(19) United States
(12) Patent Application Publication
(10) Pub. No.: US 2014/0097169 A1
(43) Pub. Date: Apr. 10, 2014

(54) FLOOR HEATING SYSTEM WITH FLEXIBLE AND STRETCHABLE ANTI-FRACTURE

(71) Applicant: FLEXTHERM INC., Longueuil (CA)

(72) Inventor: Philippe CHARRON, Boucherville (CA)

(73) Assignee: FLEXTHERM INC., Longueuil (CA)

(21) Appl. No.: 13/929,315

(22) Filed: Jun. 27, 2013

(30) Foreign Application Priority Data
Oct. 10, 2012 (CA) 2792370

(51) Int. Cl. F24D 13/02; H05B 3/28

(52) U.S. Cl. CPC F24D 13/024; H05B 3/28
USPC 219/213; 52/745.05

(57) ABSTRACT

A floor heating system is comprised of one or more heating wire flexible support meshing secured to a flexible and stretchable anti-fracture membrane formed of a material having elastic properties. The anti-fracture membrane is adapted to be secured to a surface of a sub-floor. The anti-fracture membrane also has a core thickness sufficient whereby the elastic properties of the core will stretch to absorb displacement in the lower surface thereof which is secured to the sub-floor to prevent transfer of the displacement to the heating wire support members equipped with heating wires and having a cementitious material set thereon.

### TECHNICAL FIELD

The present invention relates to a floor heating system and its method of construction and wherein one or more heating wire support members are secured to a flexible and stretchable anti-fracture membrane for connection to a sub-floor and wherein the membrane absorbs displacement of the sub-floor by stretching.

### BACKGROUND ART

It is known to construct electric radiant heating floors whereby to allow the heat generated in the floor to radiate into a room. This is particularly so in the construction of bathrooms or other rooms where it is desirable to have a warm floor surface whereby a person walking on the floor with bare feet or with socks does not have the feeling of a cold floor. It is also desirable to heat the floor of a room subjected to water or snow to evaporate same.

Commonly, these floors are constructed by securing wire support strips or meshing directly on the sub-floor by gluing and then securing heating wires in a desired path to the heating wire support members and thereafter applying a cementitious material thereover to form a cement floor on which a desired floor covering, such as ceramic tiles or carpet, can be adhered. A problem that arises with such floors is that any movement in the sub-floor will be immediately transferred to the set cement and cause it to crack and often cause a fracture in a heating wire captive in the cement thereby requiring expensive repairs. Complex support sheets have been developed whereby to uncouple a sub-floor to a main cement floor to prevent fracture but such members are complex in structure, are thick and are not adapted for heated floors. Reference is made to U.S. Pat. No. 6,434,901 which describes such an uncoupling system. Such support structure is not, however, suitable for heated flooring. It is also known to use spacer plates having spacers on the bottom of the plate to form a hollow floor and grooves in the top surface of the plate to hold heating or cooling pipes. It is also known to secure a fiber mat on a sub-floor or layers thereof in addition to the spacer plate and this results in a costly installation.

U.S. Pat. No. 8,176,694 describes a support structure that combines the established functionality of both the commonly used support structure and a commonly used heating structure into a single structure that supports a tiled floor to prevent fractures and failure and also supports a heating cable to heat the floor. As such, the need for a separate heating structure is eliminated. However, such structures are expensive to produce and are secured directly to a sub-floor surface and any shifting in the sub-floor will be transmitted into the support structure and results in cracks developing in the set mortar.

A more cost-efficient and easy-to-install floor heating system which prevents the transfer of movement in the sub-floor to the heating wire supports and the set concrete is desired. It is also desirable that the floor heating system be integrated and easy-to-install and be supplied in sheet or roll form.

### SUMMARY OF INVENTION

It is a feature of the present invention to provide a floor heating system which substantially overcomes the above-mentioned disadvantages of the prior art and provides the above needs.

According to the above feature, from a broad aspect, the present invention provides a floor heating system comprising one or more heating wire support members having heating wire support and guiding means to secure and guide one or more heating wires along a desired path on an upper surface thereof. A lower surface of the one or more heating wire support members is secured to the surface of a flexible anti-fracture membrane formed of a material having stretchable elastic properties. A lower surface of the flexible anti-fracture membrane is adapted for securement to a floor surface. The upper surface of the one or more heating wire support members is adapted to receive a cementitious material to embed the one or more heating wires and the heating wire support members therein. The flexible anti-fracture membrane has a core of predetermined thickness whereby the elastic properties of the core will stretch to absorb displacement in the lower surface thereof caused by displacement in the floor surface to prevent transfer of the displacement to the lower surface of the heating wire support members secured to the upper surface of the flexible anti-fracture membrane and the cementitious material set on the upper surface of the flexible anti-fracture membrane.

According to a further broad aspect of the present invention there is provided a method of constructing a heated floor surface having one or more heating wires therein. The method comprises the steps of: i) securing one or more heating wire support members having heating wire support and guiding means to a surface of a flexible anti-fracture membrane formed of a material having elastic properties, the flexible anti-fracture membrane having a core of predetermined thickness; ii) gluing a lower surface of the flexible anti-fracture membrane on a floor surface of a sub-floor; iii) securing one or more heating wires to the heating wire support and guiding means along one or more desired paths; iv) connecting the heating wires to a cold lead of a thermostat; v) applying a cementitious slurry over the one or more heating wire support members to embed the heating wires and the support members in the slurry; vi) applying a surface covering material on the cementitious surface; and wherein the flexible anti-fracture member core thickness is sufficient for the elastic properties thereof to stretch to absorb displacement in the lower surface thereof caused by shifting in the sub-floor and not be transferred to the upper surface of the anti-fracture membrane.

According to a still further broad aspect of the present invention there is provided a flexible heating wire support meshing for the construction of heated floors. The flexible heating wire support meshing comprises a flexible anti-fracture membrane formed of a material having elastic properties and having a core of predetermined thickness to cause relative movement between an upper and a lower surface thereof. One or more heating wire support members, having heating wire support and guiding means, are secured to the upper surface of the flexible anti-fracture membrane. The lower surface of the flexible anti-fracture membrane is adapted for securement to a surface of a sub-floor wherein the elastic properties of the core between the lower and upper surfaces will stretch to absorb any displacement in the lower surface caused by shifting of the sub-floor and not be transferred to the upper surface of the flexible anti-fracture membrane.

According to a still further broad aspect of the present invention, the flexible anti-fracture membrane is a composite membrane formed of a core sheet of stretchable material and opposed attachment sheets bonded thereto for securement to the lower surface of one or more heating wire support members and a sub-floor surface, respectively. The composite membrane also has thermal and sound insulating properties.

### BRIEF DESCRIPTION OF DRAWINGS

A preferred embodiment of the present invention will now be described with reference to the accompanying drawings in which:

FIG. 1 is a perspective view showing the basic elements in the construction of the flexible heating wire support meshing of the present invention;

FIG. 2 is a fragmented section view showing a floor heating system incorporating therein the flexible heating wire support meshing of the present invention;

FIG. 3 is an enlarged view showing the interconnection of heating wire support members to a sub-floor through the flexible anti-fracture membrane of the present invention;

FIG. 4 is an enlarged view showing a portion of a typical heating wire flexible support member which forms a meshing and secured to the flexible anti-fracture membrane;

FIG. 5 is a fragmented section view illustrating the method of constructing a heated surface using the flexible heating wire support meshing of the present invention;

FIG. 6 is a section view showing the construction of a composite anti-fracture membrane; and

FIG. 7 is a plan view showing a sheet of flexible heating wire support meshing constructed in accordance with the present invention and comprised of a plurality of heating wire support members interconnected together and one or more heating wires disposed in desired paths and interconnected to a cold lead of a thermostat.

### DESCRIPTION OF PREFERRED EMBODIMENTS

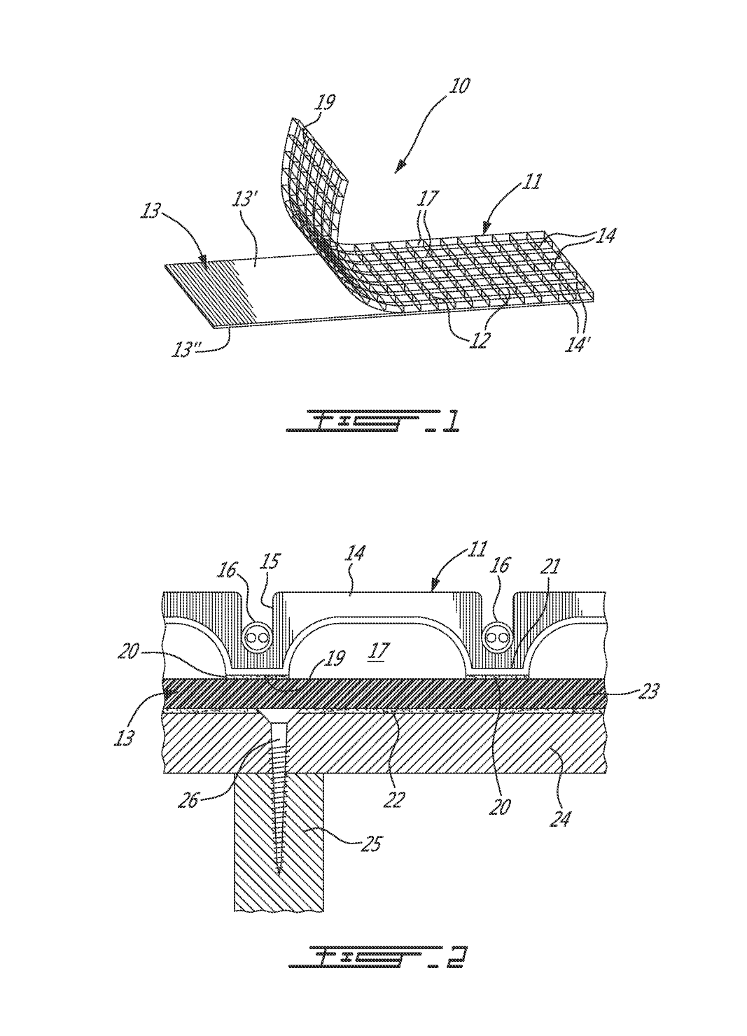

Referring now to FIGS. 1 to 3, there will be described the floor heating system of the present invention incorporating therein a flexible anti-fracture membrane.

As shown in FIG. 1, a flexible heating wire support meshing 10 constructed in accordance with the present invention comprises a flexible heating wire support meshing 11, herein comprised of a plurality of flexible plastic molded mats 12 interconnected together to form a sheet. The sheet of flexible plastic molded mats 12 is herein secured such as by gluing, to a flexible and stretchable anti-fracture membrane 13.

The flexible anti-fracture membrane 13 is formed of a material having elastic properties capable of recovering its shape and having a core of predetermined thickness to cause relative movement between an upper surface 13′ and a lower surface 13″ thereof. Typically, this flexible and stretchable anti-fracture member may be constructed of rubber material or woven stretchable yarns stitched in a pattern to produce a thickness sufficient to decouple the lower surface thereof 13″ from the upper surface 13′ thereof when the lower surface is stretched or displaced.

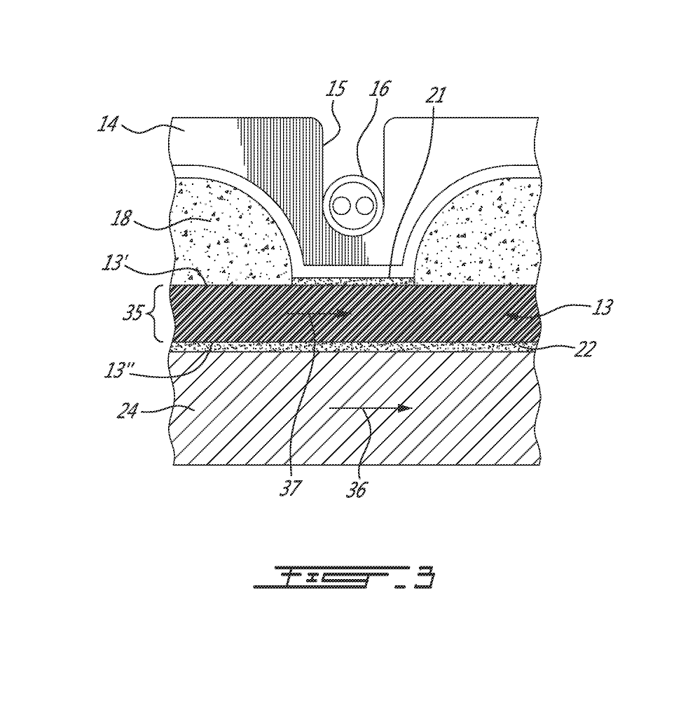

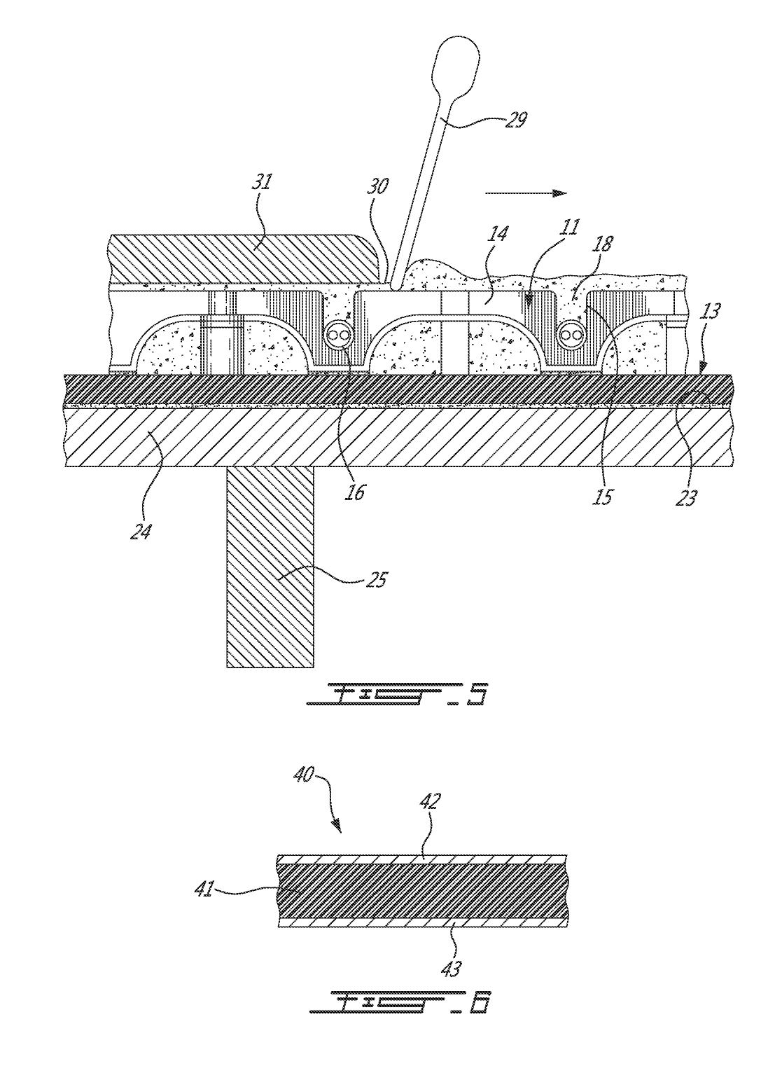

As shown in FIGS. 1 and 2, the heating wire support meshing 11 is formed by interconnected bridge formations 14 and 14′ interconnected transverse to one another at their crossings. The bridge formations 14 are provided with wire receiving slots 15 aligned to constitute guide means for the heating wires. The heating wires 16 are retained in the lots 15 by suitable means as described in my co-pending U.S. Patent Publication No. US-2010-0065548-A1, entitled “Heating Wire Support Meshing and Method of Constructing a Heated Surface With Same”. The heating wire support meshing 11 also delineates large openings 17 between the bridge formations 14 and 14′ for the reception of a cementitious material 18 therein (see FIG. 5) in the construction of a heated floor.

As shown in FIGS. 1 and 2, the lower surface 19 of the heating wire support member or meshing 11 is secured to the upper surface 13′ of the flexible anti-fracture membrane 13, herein by glue 20 applied to the base 21 of the supports of the bridge formations 14. The lower surface 13″ of the flexible anti-fracture membrane 13 is glued along its entire surface by glue 22 to the top surface 23 of the sub-floor 24. As shown in FIG. 2, the sub-floor 24 is comprised of plywood sheeting or the like secured to joists 25 by screw fasteners 26. After the heating wires 16 have been placed along a desired pattern such as the pattern 27 shown in FIG. 7, and connected to a cold wire 28 which is connected to a thermostat 29, it is now ready to receive the cementitious material 18 thereover whereby to embed both the heating wires 16 and the heating wire support meshing or members 11 therein. By the use of a ribbed trawl 29, ribs 30 of the cementitious material or mortar 18 are formed above the top surface of the heating wire support meshing 11 and ceramic tiles 31 are then positioned thereover to complete a heating floor structure. Alternatively, the top surface of the cementitious material may be made flat and let to set whereby to glue to its top surface carpet material or other desired surface material such as floating floor boards, etc.

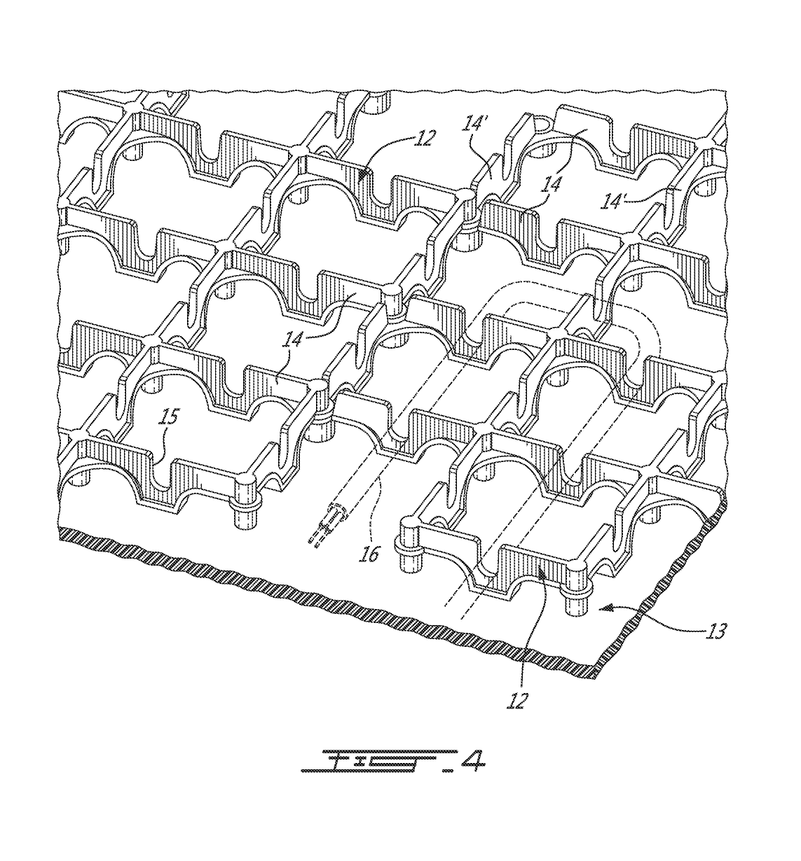

Referring again to FIG. 3 and as pointed out hereinabove, the flexible anti-fracture membrane 13 has a core thickness 35, depending on the flexible material utilized, sufficient to stretch or deform whereby to absorb the displacement in the lower surface 13″ thereof caused by any displacement or shifting of the sub-floor 24 as indicated by arrow 36. The membrane 13 will also deform to absorb irregularities such as nail or screw heads in the sub-floor surface.

Any shifting of the sub-floor will cause a corresponding shifting in the flexible core material 35, as indicated by arrow 37 in FIG. 3, and this shifting will occur in the lower section of the core whereby the upper surface 13 will not be subjected to any displacement with the core absorbing all of the displacement. Accordingly, such displacement will not fracture the cementitious material 18 which can also result in the fracture of a heating wire 16 captive therein and causing malfunction of the heated floor and expensive repair, as above-mentioned.

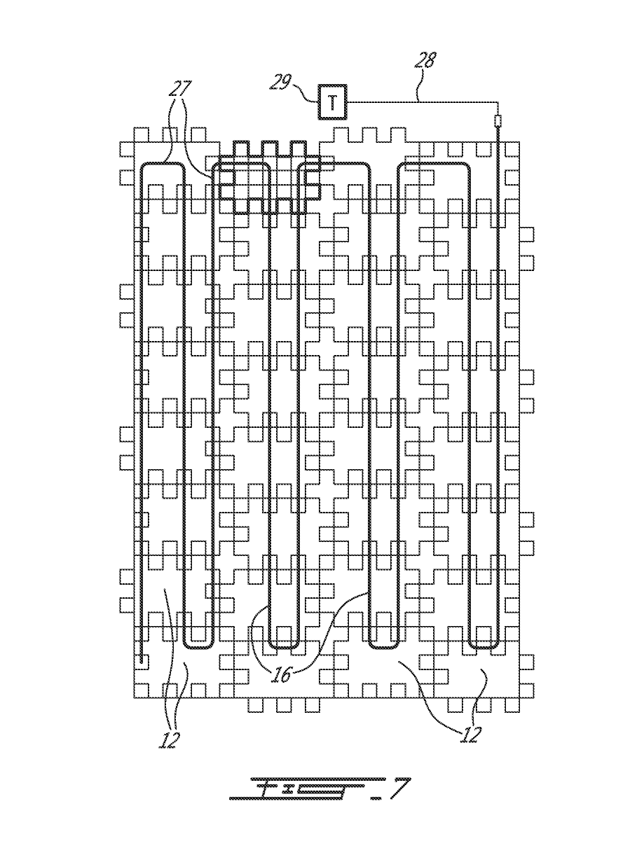

With reference now to FIG. 6, there is shown another construction of the flexible anti-fracture membrane. As hereinshown, it is comprised of a composite flexible membrane 40 formed of a core sheet 41 of stretchable and flexible material, such as rubber or a woven fabric of stretchable yarns or other suitable stretchable core material. On opposed faces of the core sheet 41 is bonded thin sheets of non-stretchable material such as a fine mesh screen material or a fiberglass sheet or other suitable non-stretchable but flexible materials. One such sheet 42 is bonded to the top surface of the flexible core and another sheet 43 is bonded to the bottom surface of the flexible core. The top and bottom sheets 42 and 43 are bonded respectively to the lower surface of the wire support meshing 11 and the top surface 23 of the sub-floor 24.

The bonded wire support meshing 11 and flexible anti-fracture membrane 13 may be pre-glued together and supplied in sheet form, preferably in roll and which sheet is easily cut to cover floor surfaces of different shapes and sizes to cover an entire floor surface prior to the assembly of heating wires thereon in desired patterns. It is pointed out that flexible anti-fracture membrane 13 inherently provides thermal and sound damping between the heated floor and the area under the sub-floor. It also provides vibration damping.

FIG. 5 illustrates the method of construction of a heated floor surface utilizing the anti-fracture membrane of the present invention. Essentially, the method comprises securing one or more heating wire support members 11 to the upper surface 13′ of the flexible and stretchable anti-fracture membrane 13 which has an elastic core of predetermined thickness. The lower surface 13″ of the flexible anti-fracture membrane 13 is glued over the surface 23 of the sub-floor 24. One or more heating wires 16, such as shown in FIGS. 4 and 7, are secured to the wire support meshing 11 in the slot 16 and connected to the cold lead 28 of the thermostat 29 as shown in FIG. 7. A cementitious slurry 18 is then applied over the heating wire support members to embed the heating wires 16 and the support meshing 11 in the slurry. A surface covering, such as ceramic tiles 31 or carpeting (not shown), is then secured to the top surface of the cementitious material, as previously described. Any displacement in the sub-floor 24, as shown in FIG. 3, is absorbed by the flexible anti-fracture membrane as above-described with reference to FIG. 3.

It is pointed out that the heating wire support meshing 11 may be glued to the anti-fracture membrane 13 and heating wires secured to the meshing 11 at a manufacturing plant with the assembly then rolled up for delivery in roll form. Such would result in quick installation by unskilled labour.

It is within the ambit of the present invention to cover any obvious modifications of the preferred embodiment described herein, provided such modifications fall within the scope of the appended claims.

1. A floor heating system comprising one or more heating wire support members having heating wire support and guiding means to secure and guide one or more heating wires along a desired path on an upper surface thereof, a lower surface of said one or more heating wire support members being secured to an upper surface of a flexible anti-fracture membrane formed of a material having stretchable elastic properties, a lower surface of said flexible anti-fracture membrane being adapted for securement to a floor surface, said upper surface of said one or more heating wire support members being adapted to receive a cementitious material to embed said one or more heating wires and said heating wire support members therein, said flexible anti-fracture membrane having a core of predetermined thickness whereby said elastic properties of said core will stretch to absorb displacement in said lower surface thereof caused by displacement in said floor surface to prevent transfer of said displacement to said lower surface of said heating wire support members secured to the upper surface of said flexible anti-fracture membrane and said cementitious material set on said upper surface of said flexible anti-fracture membrane.

2. A floor heating system as claimed in claim 1 wherein said lower surface of said flexible anti-fracture membrane is glued to said floor surface.

3. A floor heating system as claimed in claim 2 wherein said floor surface is a wood floor surface.

4. A floor heating system as claimed in claim 1 wherein said flexible anti-fracture membrane is a rubber or plastic sheet.

5. A floor heating system as claimed in claim 1 wherein said flexible anti-fracture membrane is a woven fabric material constructed of stretchable yarns and having a woven pattern of sufficient thickness to absorb said displacement of said lower surface thereof.

6. A floor heating system as claimed in claim 1 wherein ceramic tiles are secured on a top face of said mortar coating.

7. A floor heating system as claimed in claim 1 wherein said one or more heating wire support members are constituted by one or more plastic molded flexible plastic mats having interconnected bridge formations provided with wire receiving slots aligned to constitute said guiding means for said heating wires, and openings between said bridge formations to receive said cementitious material therein.

8. A floor heating system as claimed in claim 7 wherein said flexible anti-fracture membrane is glued to at least a lower surface of some of said bridge formations.

9. A floor heating system as claimed in claim 1 wherein said flexible anti-fracture membrane is a composite membrane formed of a core sheet of flexible and stretchable material and opposed attachment sheets bonded thereto for securement to said lower surface of said one or more heating wire support members and said floor surface, respectively, said composite membrane also having thermal and sound insulating properties.

10. A method of constructing a heated floor surface having one or more heating wires therein, said method comprising the steps of:
i) securing one or more heating wire support members having heating wire support and guiding means to an upper surface of a flexible and stretchable anti-fracture membrane formed of a material having elastic properties, said flexible anti-fracture membrane having a core of predetermined thickness;
ii) gluing a lower surface of said flexible anti-fracture membrane over a floor surface of a sub-floor;
iii) securing one or more heating wires to said heating wire support and guiding means along one or more desired paths;
iv) connecting said heating wires to a cold lead of a thermostat;
v) applying a cementitious slurry over said one or more heating wire support members to embed said heating wires and said support members in said slurry;
vi) applying a surface covering material on said cementitious surface;
and wherein said flexible anti-fracture membrane core thickness is sufficient for said elastic properties to stretch to absorb displacement in said lower surface thereof caused by shifting in said sub-floor and to prevent said displacement to be transferred to said upper surface of said anti-fracture membrane.

11. A method as claimed in claim 10 wherein said step vi) comprises applying a ceramic tile covering on an upper surface of said cementitious slurry.

12. A method as claimed in claim 10 wherein said steps ii) to v) are effected in a continuous sequence.

13. A method as claimed in claim 10 wherein said steps ii) to vi) are effected in a continuous sequence.

14. A method as claimed in claim 10 wherein said step i) is effected at a manufacturing plant and further comprises rolling a predetermined length of said flexible and stretchable anti-fracture membrane having said heating wire support members secured thereon as well as said heating wires to form a supply roll, said heating wire support members being flexible support meshing.

15. A method as claimed in claim 10 wherein said step i) comprises gluing at least portions of an underface of said heating wire support members to said upper surface of said flexible anti-fracture membrane.

16. A flexible heating wire support meshing for the construction of heated floors, said flexible heating wire support meshing comprising a flexible and stretchable anti-fracture membrane formed of a material having elastic properties and having a core of predetermined thickness to cause relative movement between an upper and lower surface of said membrane, one or more heating wire support members having heating wire support and guiding means secured to said upper surface of said flexible and stretchable anti-fracture membrane, said lower surface of said anti-fracture membrane being adapted for securement to a sub-floor wherein said elastic properties of said core between said lower and upper surfaces will stretch to absorb any displacement in said lower surface caused by shifting of said sub-floor and not be transferred to said upper surface of said flexible anti-fracture membrane.

17. A heating wire support meshing as claimed in claim 16 wherein said lower surface of said anti-fracture membrane is glued to said floor surface.

18. A heating wire support meshing as claimed in claim 17 wherein said floor surface is a wood floor surface.

19. A heating wire support meshing as claimed in claim 16 wherein said anti-fracture membrane is a rubber sheet.

20. A floor heating system as claimed in claim 16 wherein said anti-fracture membrane is a woven fabric material constructed of stretchable yarns and having a woven pattern of sufficient thickness to absorb said displacement of said lower surface thereof.

21. A heating wire support meshing as claimed in claim 16 wherein said heating wire support meshing is a plastic molded flexible mat having interconnected bridge formations provided with wire receiving slots aligned to constitute said guiding means for said heating wires, and openings between said bridge formations to receive said cementitious material therein

22. A heating wire support meshing as claimed in claim 16 wherein said anti-fracture membrane is a composite membrane formed of a core sheet of stretchable elastic material and having opposed attachment sheets bonded thereto for immovable securement to said lower surface of said one or more heating wire support members and said floor surface respectively, said composite membrane also having thermal and sound insulating properties.
